(19) United States
(12) Patent Application Publication
(10) Pub. No.: US 2022/0251485 A1
(43) Pub. Date: Aug. 11, 2022

(54) DUAL FUNCTION MILK, MILKSTONE CLEANING TABLET

(71) Applicant: Urnex Brands, LLC, Elmsford, NY (US)

(72) Inventors: Kofi AMOAKO, New Windsor, NY (US); Gabriel ODAME, Bronx, NY (US); Jamil AL-ASRI, East Elmhurst, NY (US)

(21) Appl. No.: 17/248,818

(22) Filed: Feb. 9, 2021

(51) Int. Cl. C11D 17/00; C11D 1/08; C11D 1/22; C11D 3/00; C11D 3/10; C11D 3/06

(52) U.S. Cl. CPC C11D 17/0078; C11D 1/08; C11D 3/06; C11D 3/0047; C11D 3/10; C11D 1/22

(57) ABSTRACT

Described is a dual function cleaning tablet comprising: a first portion comprising an alkaline cleaning formulation; and a second portion comprising an acidic cleaning formulation.

### FIELD

The instant disclosure relates generally to a cleaning tablet for cleaning machines dispensing hot milk.

### BACKGROUND

Drink dispensing machines that include equipment for steaming, frothing and dispensing hot milk, such as automatic and semi-automatic coffee machines with milk systems, need regular cleaning to remove milk residues as well as buildup scale and milkstone deposits in order to maintain optimal performance. However, efficient cleaning of milk stain, scale and milkstones (mineral salts: a heterogeneous mixture of organic and inorganic materials that adheres to heated surfaces) is hard to obtain in one cleaning system.

It is a known to use alkaline or acidic cleaning formulations to clean milk systems each with its own benefits. In applications of automatic and semi-automatic coffee machines using thin tubing, the selected cleaner most effectively remove residual milk without causing curdling (when acidified milk proteins denature and form clumps or coagulate) which reduces the solubility and flushability of the milk through such tubing. When this happens, the tubes may clog and cause backpressure that can adversely affect the machine.

Alkaline cleaning formulations have been found to be effective at removing milk stains in such applications without causing curdling. However, they are ineffective at removing milkstones as an acid is required to react with (neutralize) and dissolve the mineral salts.

### SUMMARY

A dual function cleaning tablet comprising: a first portion comprising an alkaline cleaning formulation comprising: one or more first builder components comprising one or more members of the group consisting of: one or more carbonates, one or more phosphates and one or more phosphonates; one or more complexing agents selected from the group consisting of: tetrasodium iminodisuccinate, sodium citrate and methylglycinediacetic acid trisodium salt (MGDA-Na3); one or more surfactants; one or more binder/lubricant components comprising one or more members of the group consisting of: polyethylene glycols with molecular weights between 300 to 20000, polyvinylpyrrolidone (PVP) and pregelatinized starch; and one or more stabilizing compounds comprising one or more members of the group consisting of one or more stabilizing acids and monosodium phosphate; and a second portion comprising an acidic cleaning formulation comprising an acid component comprising one or more cleaning acids each having a pH of about 1 to 3 in a 1 M aqueous solution; one or more second builder components comprising one or more carbonates; one or more binder/lubricant components comprising one or more members of the group consisting of: polyethylene glycols with molecular weights between 300 to 20000, polyvinylpyrrolidone (PVP) and pregelatinized starch; and a pH dependent sustained release matrix comprising one or more nonionic polymers selected from the group consisting of: dewaxed shellac and polyvinylpyrrolidone.

### BRIEF DESCRIPTION OF THE DRAWINGS

The features described in this disclosure are set forth with particularity in the appended claims. These features and attendant advantages will become apparent from consideration of the following detailed description, taken in conjunction with the accompanying drawings. One or more embodiments are now described, by way of example only, with reference to the accompanying drawings wherein like reference numerals represent like elements and in which:

FIG. 1 is a perspective view of a dual function cleaning tablet according to one embodiment of the present invention.

FIG. 2 is a schematic diagram of using the dual function tablet of FIG. 1 to clean the tubing of a drink dispensing machine.

FIG. 3 is a perspective view of a dual function cleaning tablet according to one embodiment of the present invention.

FIG. 4 is a top view of a dual function cleaning tablet according to one embodiment of the present invention.

FIG. 5 is a side view of the dual function cleaning tablet of FIG. 4.

FIG. 6 is a side view of the dual function cleaning tablet of FIG. 4.

FIG. 7 is a top view of a dual function cleaning tablet according to one embodiment of the present invention.

FIG. 8 is a side view of the dual function cleaning tablet of FIG. 7.

FIG. 9 is a top view of a dual function cleaning tablet according to one embodiment of the present invention.

### DETAILED DESCRIPTION OF THE PRESENT EMBODIMENTS

For purposes of the present invention, it should be noted that to provide a more concise description, some of the quantitative expressions given herein are not qualified with the term “about.” It is understood that whether the term “about” is used explicitly or not, every quantity given herein is meant to refer to the actual given value, and it is also meant to refer to the approximation to such given value that would reasonably be inferred based on the ordinary skill in the art, including approximations due to the experimental and/or measurement conditions for such given value.

In the following description and claims all percentages are parts by weight unless indicated otherwise.

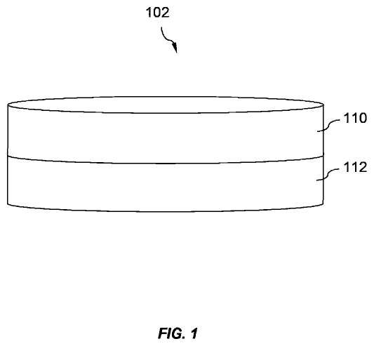

FIG. 1 shows a dual function tablet 102 according to one embodiment of the present invention that includes an alkaline cleaning formulation portion 110 and an acidic cleaning formulation portion 112 where alkaline cleaning formulation portion 110 and acidic cleaning formulation portion 112 are adjacent layers of a bilayer tablet. Alkaline cleaning formulation portion 110 comprises an alkaline cleaning formulation and acidic cleaning formulation portion 112 comprises an acidic cleaning formulation. Dual function tablet 102 is a flat faced disc shaped tablet.

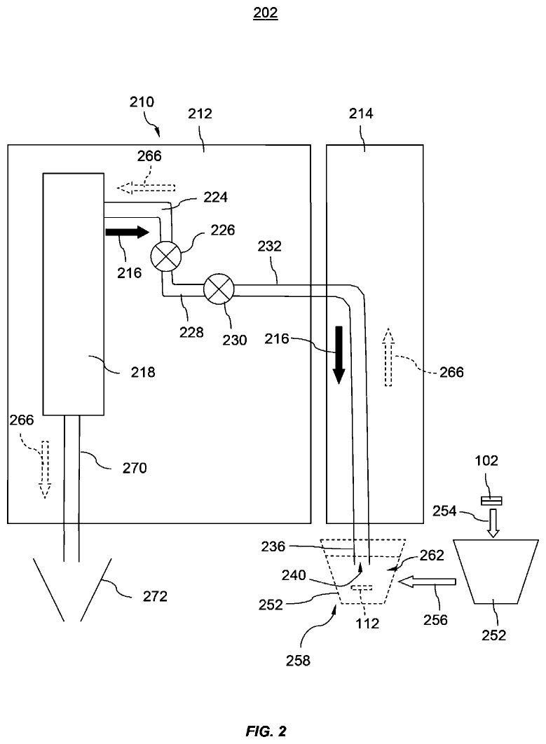

According to one embodiment of the present invention, alkaline cleaning formulation portion 110 is designed to immediately dissolve when dual function tablet 102 is immersed in water to release the alkaline cleaning formulation that mixes with the water to produce an alkaline cleaning solution. A portion of the alkaline cleaning solution is then pulled by suction into a drink dispensing machine to clean milk residues in the tubing of the drink dispensing machine After a period of time, such as within 3 minutes, acidic cleaning formulation portion 112 starts to dissolve to release the acid cleaning formulation which mixes with the remaining alkaline cleaning solution that has not been pulled into the drink dispensing machine to produce an acidic cleaning solution. In one embodiment of the present invention acidic cleaning formulation portion completely dissolves to release substantially all of the acidic cleaning formulation about 3 minutes after acidic cleaning formulation portion 112 begins to dissolve. The acidic cleaning solution is then pulled into the drink dispensing machine to clean milk scale and milk stones in the tubing of the drink dispensing machine. A more detailed description of how dual function tablet 102 may be used to clean a drink dispensing machine is provided below in the description of FIG. 2. In one embodiment of the present invention, the ratio of the amount of the acidic cleaning formulation to the amount of the alkaline cleaning formulation in dual function tablet 102 is from about 1:1 to about 4:1. In one embodiment of the present invention, the ratio of the amount of the acidic cleaning formulation to the amount alkaline cleaning formulation in dual function tablet 102 is at least 2:1 to thereby provide sufficient acid to neutralize alkaline cleaning solution and produce an effective acidic cleaning environment in the drink dispensing machine, even without pulling some of the alkaline cleaning solution out of the drink dispensing machine.

The time required for the alkaline cleaning formulation portion to dissolve and the time required for the acid cleaning formulation portion to dissolve depend on the particular conditions in which a dual formulation tablet of the present invention is used and on the particular makeups of the alkaline cleaning formulation portion and the acid cleaning formulation layer of a dual formulation tablet of the present invention. In one embodiment of the present invention, in water of at about 70° C., the acid cleaning formulation fully dissolves between 6 to 10 minutes following immersion in the water or about 3 to 7 minutes following dissolution of the alkaline cleaning formulation portion.

FIG. 2 shows a process 202 of cleaning a drink dispensing machine 210 using a dual function tablet 102 according to one embodiment of the present invention. Drink dispensing machine 210 includes an expresso machine 212 and a refrigerator 214. Milk travels in drink dispensing machine 210 along a milk path in the direction shown by arrows 216. In regular operation, milk is mixed with steam to create hot milk or foamed milk in mixing chamber 218. The hot milk or foamed milks travel from mixing chamber 218 through tubing 224 through valve 226 which opens and closes to allow water and/or milk to travel through drink dispensing machine 210. Hot water travels through tubing along a water path (not shown in FIG. 2), which connects with the milk path at valve 226. After passing through valve 226, the hot milk or foamed milk travels through tubing 228 and then through valve 230 which opens and closes to allow water and/or milk to travel through drink dispensing machine 210. After passing through valve 230, the hot milk or foamed milk travels through tubing 232 which passes through refrigerator 214, thereby chilling the hot milk or foamed milk, and is dispensed at tube end 236 through an opening 240 into a cup, mug, or other container (not shown in FIG. 2).

Also, shown in FIG. 2 is a process 202 of cleaning the internal tubing of drink dispensing machine 210. Dual function tablet 102 is placed in an open container 252 as indicated by arrow 254. Open container 252 is then placed, as shown by arrow 256, in position 258, shown by shadow lines where hot water from the water path is dispensed from opening 240. As the hot water fills open container 252, alkaline cleaning formulation portion 110 dissolves to allow the alkaline cleaning formulation in alkaline cleaning formulation portion 110 to mix with hot water to thereby form an alkaline cleaning solution 262. Alkaline cleaning solution 262 is suctioned in the direction of arrows 266 by a pump (not shown in FIG. 2) through opening 240, tubing 232, valve 230, tubing 228, valve 226, tubing 224 and mixing chamber 218. Alkaline cleaning solution 262, which has removed and carried away residual milk and milk stains from the tubing and various internal components of dink dispensing machine 210 is then drained through tubing 270 into drain 272.

Over time, acidic cleaning formulation portion 112 dissolves to release the acidic cleaning formulation and mixes with alkaline cleaning solution 262 to thereby form an acid cleaning solution (not shown in FIG. 2). Additional hot water may be dispensed into open container 252 while acidic cleaning formulation portion 112 is dissolving to aid in the formation of the acidic cleaning solution and to make it easier to suction the acidic cleaning solution through opening 240. After alkaline cleaning solution 262 has been suctioned through drink dispensing machine 210 to remove residual milk and milkstones from drink dispensing machine 210, the acidic cleaning solution is suctioned in the direction of arrows 266 by a pump (not shown in FIG. 2) through opening 240, tubing 232, valve 230, tubing 228, valve 226, tubing 224 and mixing chamber 218. The acidic cleaning solution, which has removed and carried away milkstones and scale from the tubing and various internal components of drink dispensing machine 210 is then drained through tubing 270 into drain 272.

In one embodiment of the present invention, the alkaline cleaning formulation dissolves in the first 2 minutes, converting the water in the open container into the alkaline cleaning solution as the pH of the solution becomes alkaline, reaching a pH≤10.50. After about 2 minutes and 30 seconds, the acidic cleaning formulation begins dissolving and neutralizes the alkaline cleaning solution. At the same time, the drink dispensing machine typically would begin dispensing the available alkaline solution for cleaning. Soluble sodium salts will form during this transitional period and the pH gradually continues to drop, for example to a pH of 9.5, 9.0 or 8.7, depending on conditions in drink dispensing machine. Eventually the ratio of acid to alkaline and/or remaining soluble salts is offset, i.e., is higher on the acid side as the system converts to the acidic cleaning solution.

Although in FIG. 2, a dual function tablet according to one embodiment of the present invention is shown being used to clean the internal tubing of an expresso machine, a dual function cleaning tablet of the present invention may be used to clean a variety of drink dispensing machines such as automatic and semi-automatic coffee machines, expresso machines, etc.

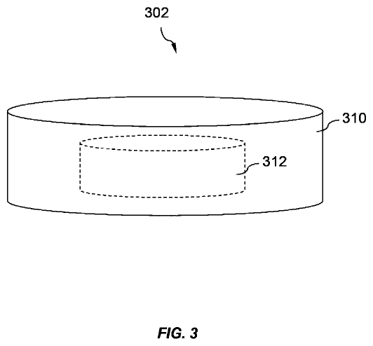

FIG. 3 shows a dual function tablet 302 according to one embodiment of the present invention that includes an alkaline cleaning formulation portion 310 and an acidic cleaning formulation portion 312 (shown with shadow lines) where alkaline cleaning formulation portion 310 encloses acidic cleaning formulation portion 312. Alkaline cleaning formulation portion 310 comprises an alkaline cleaning formulation and acidic cleaning formulation portion 312 comprises an acidic cleaning formulation. Dual function tablet 302 is a flat faced disc shaped tablet.

Alkaline cleaning formulation portion 310 is designed to immediately dissolve when dual function tablet 302 is immersed in water to release the alkaline cleaning formulation that mixes with the water to produce an alkaline cleaning solution. A portion of the alkaline cleaning solution is then pulled by suction into a drink dispensing machine to clean milk residues in the tubing of the drink dispensing machine After a period of time, such as about 3 minutes, after acidic cleaning formulation portion has been exposed to the alkaline cleaning solution by the total or partial dissolving of alkaline cleaning formulation portion 310, acidic cleaning formulation portion 312 dissolves to release the acid cleaning formulation which mixes with the remaining alkaline cleaning solution that has not been pulled into the drink dispensing machine to produce an acidic cleaning solution. In one embodiment of the present invention acidic cleaning formulation portion completely dissolves to release substantially all of the acidic cleaning formulation about 3 minutes after acidic cleaning formulation portion 112 begins to dissolve. The acidic cleaning solution is then pulled into the drink dispensing machine to clean milk scale and milk stones in the tubing of the drink dispensing machine. Dual function tablet 302 may be used to clean a drink dispensing machine, such as the drink dispensing machine shown in FIG. 2 in a similar way to how dual function tablet is used to clean the drink dispensing machine shown in FIG. 2.

In one embodiment, the present invention provides a dual function cleaning tablet that utilizes the combined benefits both alkaline and acidic cleaning formulations in one system by employing a relatively immediate release of an alkaline cleaning formulation and a controlled (sustained release) of an acidic cleaning formulation. Such system, as described above with respect to FIG. 2, allows the alkaline cleaning formulation of the cleaning tablet to fully engage and remove residual milk and milk stains in the tubes of a drink dispensing machine before the acidic cleaning formulation of the cleaning tablet is used to remove any scale and/or milkstone present.

Although the dual function tablets and layers in the embodiments of the present invention shows in FIGS. 1 and 3 are in the shape of flat discs, a dual function tablet and/or layer of the present invention may be any convenient shape such as: a convex disc, a flat or convex oval shape, a ball shape, a capsule shape, a squashed capsule shape, a ring shape, a lozenge shape, a square shape with or without rounded corners, an arc square or pillow shape, a rectangular shape with or without rounded corners, a triangular shape with or without rounded corners, an arc triangular shape, a diamond shape with or without rounded corners, a pentagonal shape with or without rounded corners, a hexagonal shape with or without rounded corners, an octagonal shape with or without rounded corners, a half moon shape, a heart shape, an ellipsoid shape etc. A dual function tablet of the present invention may have beveled edges, one or more convex sides, one or more concave sides, etc.

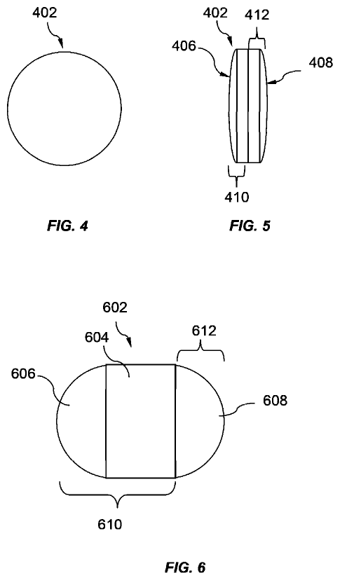

FIGS. 4, 5, 6, 7, 8 and 9 show dual function tablets having a variety of shapes according to various embodiments of the present invention.

FIGS. 4 and 5 show a dual function tablet 402 according to one embodiment of the present invention having a disc shape with convex sides 406 and 408. Dual function tablet 402 includes an alkaline cleaning formulation portion 410 and an acidic cleaning formulation portion 412 where alkaline cleaning formulation portion 410 and acidic cleaning formulation portion 412 are adjacent layers of a bilayer tablet. Alkaline cleaning formulation portion 410 comprises an alkaline cleaning formulation and acidic cleaning formulation portion 412 comprises an acidic cleaning formulation.

Although in the dual function tablet shown in FIGS. 4 and 5 the acid formulation portion is an adjacent layer to the alkaline cleaning formation portion, a dual function tablet according to one embodiment of the present invention may have the same shape as the dual function tablet of FIGS. 4 and 5, but have the alkaline cleaning formulation portion enclose the acidic cleaning formulation portion.

FIG. 6 show a dual function tablet 602 according to one embodiment of the present invention having a squashed capsule shape with a middle section 604, a dome shaped end 606 and a dome shaped end 608. Dual function tablet 602 includes an alkaline cleaning formulation portion 610 and an acidic cleaning formulation portion 612 where alkaline cleaning formulation portion 610 and acidic cleaning formulation portion 612 are adjacent layers of a bilayer tablet. Alkaline cleaning formulation portion 610 comprises an alkaline cleaning formulation and acidic cleaning formulation portion 612 comprises an acidic cleaning formulation. Middle section 604 and dome shaped end 606 comprise alkaline cleaning formulation portion 610. Dome shaped end 608 comprises acidic cleaning formulation portion 612

Although in the dual function tablet shown in FIG. 6 the acid formulation portion is an adjacent layer to the alkaline cleaning formation portion, a dual function tablet according to one embodiment of the present invention may have the same shape as the dual function tablet of FIG. 6, but have the alkaline cleaning formulation portion enclose the acidic cleaning formulation portion.

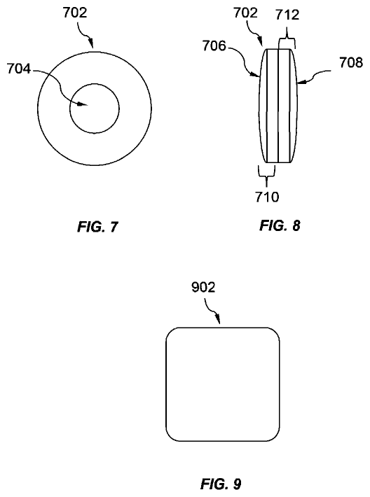

FIGS. 7 and 8 show a dual function tablet 702 according to one embodiment of the present invention having a ring shape having a central opening 704 and convex sides 706 and 708. Dual function tablet 702 includes an alkaline cleaning formulation portion 710 and an acidic cleaning formulation portion 712 where alkaline cleaning formulation portion 710 and acidic cleaning formulation portion 712 are adjacent layers of a bilayer tablet. Alkaline cleaning formulation portion 710 comprises an alkaline cleaning formulation and acidic cleaning formulation portion 712 comprises an acidic cleaning formulation.

Although in the dual function tablet shown in FIGS. 7 and 8 the acid formulation portion is an adjacent layer to the alkaline cleaning formation portion, a dual function tablet according to one embodiment of the present invention may have the same shape as the dual function tablet of FIGS. 7 and 8, but have the alkaline cleaning formulation portion enclose the acidic cleaning formulation portion.

FIG. 9 shows a dual function tablet 902 having a square shape with rounded corners according to one embodiment of the present invention.

In one embodiment, the present invention provides the ability to remove both milk stain, milkstone and other scale formation.

In one embodiment, the present invention employs one convenient cleaning step that prevents the formation of scales and milkstones and prevents in-tube milk curdling.

In one embodiment, the present invention provides the ability to use one dual function tablet in a convenient one step cleaning procedure to effectively remove dried-on, burnt-on milk stains remove and prevent milkstone and other scale buildup in drink dispensing machines that include equipment for steaming, frothing and dispensing hot milk, such as automatic and semi-automatic coffee machines with milk systems. In various embodiments of the present invention, the alkaline cleaning formulation comprises one or more builder components, one or more complexing agents, one or more surfactants and one or more stabilizing compounds.

For purposes of the present invention, the term “builder components” for an alkaline formulation of the present invention refers to one or more carbonates and/or phosphates. Suitable carbonates for use as builder components in various embodiments of the present invention include carbonates such as: sodium carbonate, sodium bicarbonate, sodium percarbonate, etc.

Suitable phosphates for use as builder components in various embodiments of the present invention include phosphates such as: sodium tripolyphosphate (STPP), trisodium phosphate (TSP), tetrapotassium pyrophosphate (TKPP), etc. Builder components serve the purpose of removing or sequestering Calcium ions (Ca²⁺) and Magnesium ions (Mg²⁺) from the water in a drink dispensing apparatus and to provide an alkaline environment. Builder components may also enhance the performance of surfactants in an alkaline cleaning formulation of the present invention.

The one or more builder components of the alkaline cleaning formulation of the dual function tablet of various embodiments of the present invention may comprise one or more carbonates that comprise about 10% to about 15% of the alkaline cleaning formulation. Suitable carbonates that may be used alone or mixed with other carbonates as builder components include but are not limited to sodium carbonate which may comprise 5% to 50% of the dual function tablet, sodium bicarbonate which may comprise 5 to 20% of the dual function tablet, sodium percarbonate which may comprise 5 to 30% of the dual function tablet.

The one or more complexing agents of the alkaline cleaning formulation of the dual function tablet of various embodiments of the present invention may comprise about 20% to about 30% of the alkaline cleaning formulation. Suitable complexing agents, which may be used alone or mixed with other complexing agents, include but are not limited to tetrasodium iminodisuccinate which may comprise 5 to 10% of the dual function tablet, sodium citrate which may comprise 10% to 20% of the dual function tablet, and trisodium salt of methylglycinediacetic acid (MGDA-Na3) which may comprise 5 to 10% of the dual function tablet. The one or more phosphates and/or the one or more phosphonates that are builder components alkaline cleaning formulations of the dual function tablet of various embodiments of the present invention may also function as complexing agents.

The one or more surfactants of the alkaline cleaning formulation of the dual function tablet of various embodiments of the present invention may include individual nonionic, cationic, amphoteric and anionic surfactants or synergistic combinations of surfactants. Suitable surfactants used in individually or in combination with each other include but not limited to alcohol ethoxylates, which may comprise 1 to 5% of the alkaline cleaning formulation and linear alkylbenzene sulfonate which may comprise 1 to 5% of the alkaline cleaning formulation.

The one or more binder/lubricant components of the of the alkaline cleaning formulation of the dual function tablet of various embodiments of the present invention may comprise 2 to 10% of the alkaline cleaning formulation. Suitable binder/lubricant components include but are not limited to polyethylene glycols with molecular weights between 300 to 20000, polyvinylpyrrolidone (PVP) and pregelatinized starch.

The one or more stabilizing compounds of the alkaline cleaning formulation of the dual function tablet of various embodiments of the present invention may collectively comprise 3 to 20% of the dual function tablet. Suitable stabilizing compounds include but are not limited to such compounds as stabilizing acids such as tartaric acid, polymers and monosodium phosphate. Suitable polymers for use as stabilizing compounds in the alkaline cleaning formulation of the dual function tablet of various embodiments of the present invention include but are not limited to polyvinylpyrolidone. One purpose of the stabilizing compounds of the alkaline cleaning formation is to prevent components of the acidic cleaning formulation from reacting with the components of the alkaline cleaning formulation before the dual function tablet is exposed to water.

The acidic cleaning formulation of various embodiments of the dual function table of the present invention comprises one or more cleaning acids, each of which is a weak to moderately strong organic or inorganic acid having a pH of about 1 to 3 in a 1 M aqueous solution of the acid. The one or more cleaning acids may comprise about 60 to about 70% of the acidic cleaning formulation. Suitable weak to moderately strong acids that may be used as cleaning acids for the acidic cleaning formulation of a dual function tablet of various embodiments of the present invention include but are not limited to sulfamic acid, tartaric acid, citric acid and maleic acid.

The one or more builder components of the acidic formulation of the dual function tablet of various embodiments of the present invention may comprise about 5 to 15% of the acidic cleaning formulation. In one embodiment of the present invention, the builder components of the present invention may comprise one or more carbonates. For example, in one embodiment of the present invention, the one or more builder components of the acidic cleaning formulation may comprise sodium bicarbonate which may comprise about 5 to 10% of the acidic cleaning formulation.

The one or more binder/lubricant components of the of the acidic cleaning formulation of the dual function tablet of various embodiments of the present invention may comprise 2 to 10% of the acidic cleaning formulation. Suitable binder/lubricant components include but are not limited to polyethylene glycols with molecular weights between 300 to 20000, polyvinylpyrrolidone (PVP) and pregelatinized starch.

The pH dependent sustained release matrix of the acidic cleaning formulation of the dual function tablet of various embodiments of the present invention may comprise 50 to 60% of the acidic cleaning formulation of the dual function tablet of various embodiments of the present invention. The pH dependent sustained release matrix may comprise one or more nonionic polymers including but not limited to the nonionic polymers dewaxed shellac and polyvinylpyrrolidone.

Aspects of the present invention will now be described by way of example.

### EXAMPLES

### Example 1

Table 1 below provides the composition of an exemplary alkaline cleaning formulation according to one embodiment of the present invention.

TABLE 1

| Component | Weight % |
|---|---|
| Sodium Bicarbonate | 47 |
| Sodium Lauryl Sulfate | 4 |
| Tetrasodium Iminodisuccinate | 10 |
| Sodium Citrate | 10 |
| Tartaric Acid | 9 |
| PEG 8000 | 5 |
| Sodium Percarbonate | 15 |

PEG 8000 is polyethylene glycol having an average molecular weight of 8000.

### Example 2

Table 2 below provides the composition of an exemplary alkaline cleaning formulation according to one embodiment of the present invention.

TABLE 2

| Component | Weight % |
|---|---|
| Sodium Carbonate | 27 |
| Sodium Bicarbonate | 20 |
| Sodium Lauryl Sulfate | 2 |
| Tetrasodium Iminodisuccinate | 6 |
| Sodium Citrate | 12 |
| Tartaric Acid | 13 |
| PEG 8000 | 5 |
| Sodium Percarbonate | 15 |

### Example 3

Table 3 below provides the composition of an exemplary acid cleaning formulation according to one embodiment of the present invention.

TABLE 3

| Component | Weight % |
|---|---|
| Sulfamic Acid | 30 |
| Tartaric Acid | 25 |
| PEG 8000 | 10 |
| PVP K30 | 25 |
| Sodium Bicarbonate | 4 |
| Tetrasodium Iminodisuccinate | 6 |

PVP K30 is a commercially available form of polyvinylpyrrolidone.

### Example 4

Table 4 below provides the composition of an exemplary acid cleaning formulation according to one embodiment of the present invention.

TABLE 4

| Component | Weight % |
|---|---|
| Sulfamic Acid | 16 |
| Citric Acid | 15 |
| Maleic Acid | 25 |
| PEG 8000 | 10 |
| PVP K30 | 25 |
| Dewaxed Shellac | 5 |
| Sodium Bicarbonate | 4 |

While particular preferred embodiments have been shown and described, those skilled in the art will appreciate that changes and modifications may be made without departing from the instant teachings. It is therefore contemplated that any and all modifications, variations or equivalents of the above-described teachings fall within the scope of the basic underlying principles disclosed above and claimed herein.

What is claimed is:

1. A dual function cleaning tablet comprising:
a first portion comprising an alkaline cleaning formulation comprising: one or more first builder components comprising one or more members of the group consisting of: one or more carbonates, one or more phosphates and one or more phosphonates; one or more complexing agents selected from the group consisting of tetrasodium iminodisuccinate, sodium citrate and methylglycinediacetic acid trisodium salt (MGDA-Na3); one or more surfactants; one or more binder/lubricant components comprising one or more members of the group consisting of: polyethylene glycols with molecular weights between 300 to 20000, polyvinylpyrrolidone (PVP) and pregelatinized starch; and one or more stabilizing compounds comprising one or more members of the group consisting of one or more stabilizing acids and monosodium phosphate; and
a second portion comprising an acidic cleaning formulation comprising an acid component comprising one or more cleaning acids each having a pH of about 1 to 3 in a 1 M aqueous solution; one or more second builder components comprising one or more carbonates; one or more binder/lubricant components comprising one or more members of the group consisting of: polyethylene glycols with molecular weights between 300 to 20000, polyvinylpyrrolidone (PVP) and pregelatinized starch; and a pH dependent sustained release matrix comprising one or more nonionic polymers selected from the group consisting of: dewaxed shellac and polyvinylpyrrolidone.

2. The dual function cleaning tablet of claim 1, wherein the ratio of the amount of the acidic cleaning formulation to the amount of the alkaline cleaning formulation is from about 1:1 to about 4:1.

3. The dual function cleaning tablet of claim 1, wherein the ratio of the amount of the acidic cleaning formulation to the amount of the alkaline cleaning formulation in the dual function cleaning tablet is at least 2:1.

4. The dual function cleaning tablet of claim 1, wherein the alkaline cleaning formulation comprises 5% to 50% sodium carbonate, 10% to 20% sodium citrate and 3 to 20% tartaric acid.

5. The dual function cleaning tablet of claim 1, wherein the acidic cleaning formulation comprises about 60% to about 70% of the acid component.

6. The dual function cleaning tablet of claim 1, wherein the alkaline cleaning formulation comprises 47% sodium bicarbonate, 4% sodium lauryl sulfate, 10% tetrasodium iminodisuccinate, 10% sodium citrate, 9% tartaric acid, 5% polyethylene glycol and 15% sodium percarbonate.

7. The dual function cleaning tablet of claim 1, wherein the alkaline cleaning formulation comprises 27% sodium carbonate, 20% sodium bicarbonate, 2% sodium lauryl sulfate, 6% tetrasodium iminodisuccinate, 12% sodium citrate, 13% tartaric acid, 5% polyethylene glycol and 15% sodium percarbonate.

8. The dual function cleaning tablet of claim 1, wherein the acid cleaning formulation comprises 30% sulfamic acid, 25% tartaric acid, 10 percent polyethylene glycol, 25% polyvinylpyrrolidone and 4% sodium bicarbonate.

9. The dual function cleaning tablet of claim 1, wherein the acid cleaning formulation comprises: 16% sulfamic acid, 15% citric acid, 25% maleic acid, 10% polyethylene glycol, 5% dewaxed shellac and 4% sodium bicarbonate.

10. The dual function cleaning tablet of claim 1, wherein the first portion and the second portion are adjacent layers of a bilayer tablet.

11. The dual function cleaning tablet of claim 1, wherein the first portion encloses the second portion.

12. The dual function cleaning tablet of claim 1, wherein the one or more cleaning acids are selected from the group consisting of: sulfamic acid, tartaric acid, citric acid and maleic acid.

13. The dual function cleaning tablet of the claim 1, wherein the first builder components comprise about 10% to about 15% of the alkaline cleaning formulation.

14. The dual function cleaning tablet of the claim 1, wherein the one or more second builder components comprise about 5 to 15% of the acidic cleaning formulation.

15. The dual function cleaning tablet of claim 1, wherein the one or more first builder components comprise one or more carbonates selected from the group consisting of: sodium carbonate, sodium bicarbonate and sodium percarbonate.

16. The dual function cleaning tablet of claim 1, wherein the one or more second builder components comprise one or more carbonates selected from the group consisting of: sodium carbonate, sodium bicarbonate and sodium percarbonate.

17. The dual function cleaning tablet of claim 1, wherein the one or more first builder components comprise one or more phosphates selected from the group consisting of: sodium tripolyphosphate (STPP), trisodium phosphate (TSP) and tetrapotassium pyrophosphate (TKPP).

18. The dual function cleaning tablet of claim 1, wherein the dual function tablet is disc shaped.

19. The dual function cleaning tablet of claim 1, wherein the dual function tablet has a squashed capsule shape.

20. The dual function cleaning tablet of claim 1, wherein the dual function tablet is ring shaped.
